(19) United States
(12) Patent Application Publication
(10) Pub. No.: US 2025/0004824 A1
(43) Pub. Date: Jan. 2, 2025

(54) FREEING SPACE IN MEMORY BY DISABLING ONE OR MORE SERVICES OF AN APPLICATION

(71) Applicant: INTERNATIONAL BUSINESS MACHINES CORPORATION, Amronk, NY (US)

(72) Inventors: Masakuni Okada, Abiko-shi (JP); Hayato Uenohara, Funabashi-shi (JP)

(21) Appl. No.: 18/342,475

(22) Filed: Jun. 27, 2023

(51) Int. Cl. G06F 9/48; G06F 9/451; G06F 9/50

(52) U.S. Cl. CPC G06F 9/485; G06F 9/451; G06F 9/5016

(57) ABSTRACT

Provided are techniques for freeing space in memory by disabling one or more services. For a first application that is executing, where the first application comprises a plurality of services, a usage rate and a memory usage of each service of the plurality of services are monitored. A request to start a second application is received. It is determined that starting the second application would result in a total memory usage exceeding a threshold. Priorities are assigned to each service of the plurality of services based on the usage rate. One or more services of the plurality of services are selected based on the priorities and the memory usage of each service. A User Interface (UI) element of each one of the selected one or more services is disabled. An amount of memory allocated to the first application is reduced, and the second application is started.

### BACKGROUND

Embodiments of the invention relate to freeing space in memory by disabling one or more services of an application. In particular, embodiments of the invention relate to identifying a service of an application that may be disabled based on the frequency of use of that service. In addition, embodiments of the invention relate to disabling and enabling the User Interface (UI) for that service dynamically based on the memory usage of an edge device.

Recently, due to the improvement of Central Processing Units (CPUs), storage, memory, and network performance of an edge device (e.g., a car navigation system), the application management system that expands the edge device capability by installing and updating a new workload as an application (App) via a cloud server is becoming an attractive solution for better user experience. As such, an application management system may provide the capability to implement the new workload as an application, install/update the application from the cloud server, and manage the lifecycle (start, stop, restart, etc.) of the application.

As the number of applications increase, there is a problem of running out of the edge device's limited memory. In conventional systems, the maximum memory size (e.g., a specific size or rank of allowed memory) is defined for each application, and application execution management is performed based on the status of system memory and the defined maximum memory size of the applications. For example, if memory is not enough for starting a new application, the start for that application may be failed or some running application may be terminated to free space for running the new application.

### SUMMARY

In accordance with certain embodiments, a computer-implemented method comprising operations is provided for freeing space in memory by disabling one or more services of an application. In such embodiments, for a first application that is executing, where the first application comprises a plurality of services, a usage rate and a memory usage of each service of the plurality of services are monitored. A request to start a second application is received. It is determined that starting the second application would result in a total memory usage exceeding a threshold. Priorities are assigned to each service of the plurality of services based on the usage rate. One or more services of the plurality of services are selected based on the priorities and the memory usage of each service. A User Interface (UI) element of each one of the selected one or more services is disabled. An amount of memory allocated to the first application is reduced, and the second application is started.

In accordance with other embodiments, a computer program product comprising a computer readable storage medium having program code embodied therewith is provided, where the program code is executable by at least one processor to perform operations for freeing space in memory by disabling one or more services of an application. In such embodiments, for a first application that is executing, where the first application comprises a plurality of services, a usage rate and a memory usage of each service of the plurality of services are monitored. A request to start a second application is received. It is determined that starting the second application would result in a total memory usage exceeding a threshold. Priorities are assigned to each service of the plurality of services based on the usage rate. One or more services of the plurality of services are selected based on the priorities and the memory usage of each service. A User Interface (UI) element of each one of the selected one or more services is disabled. An amount of memory allocated to the first application is reduced, and the second application is started.

In accordance with yet other embodiments, a computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations for freeing space in memory by disabling one or more services of an application. In such embodiments, for a first application that is executing, where the first application comprises a plurality of services, a usage rate and a memory usage of each service of the plurality of services are monitored. A request to start a second application is received. It is determined that starting the second application would result in a total memory usage exceeding a threshold. Priorities are assigned to each service of the plurality of services based on the usage rate. One or more services of the plurality of services are selected based on the priorities and the memory usage of each service. A User Interface (UI) element of each one of the selected one or more services is disabled. An amount of memory allocated to the first application is reduced, and the second application is started.

### BRIEF DESCRIPTION OF THE SEVERAL VIEWS OF THE DRAWINGS

Referring now to the drawings in which like reference numbers represent corresponding parts throughout:

FIG. 1 illustrates a computing environment in accordance with certain embodiments.

FIG. 2 illustrates, in a block diagram, a computing environment in accordance with certain embodiments.

FIG. 3 illustrates an example of memory waste in accordance with certain embodiments.

FIG. 4 illustrates an example of swapping applications in accordance with certain embodiments.

FIG. 5 illustrates an example of disabling services in accordance with certain embodiments.

FIG. 6 illustrates an example of starting an application with disabled services in accordance with certain embodiments.

FIG. 7 illustrates an example of allocating temporary memory in accordance with certain embodiments.

FIG. 8 illustrates service attributes in accordance with certain embodiments.

FIG. 9 illustrates an expression of a service attribute in accordance with certain embodiments.

FIG. 10 illustrates examples of Application Programming Interfaces (APIs) in accordance with certain embodiments.

FIG. 11 illustrates an example of using an API in accordance with certain embodiments.

FIG. 12 illustrates selection of a service to disable using a hierarchical structure of the services in accordance with certain embodiments.

FIG. 13 illustrates use of a hierarchical structure to define a service to return to in accordance with certain embodiments.

FIG. 14 illustrates, in a block diagram, interaction of components of the memory management code in accordance with certain embodiments.

FIGS. 15A and 15B illustrate, in a flowchart, operations for disabling one or more services to start a new application in accordance with certain embodiments.

FIG. 16 illustrates, in a flowchart, operations for enabling one or more services in accordance with certain embodiments.

FIGS. 17A and 17B illustrate, in a flowchart, operations for temporarily disabling one or more services to swap applications in accordance with certain embodiments.

FIGS. 18A and 18B illustrate, in a flowchart, freeing space in memory by disabling one or more services of an application in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

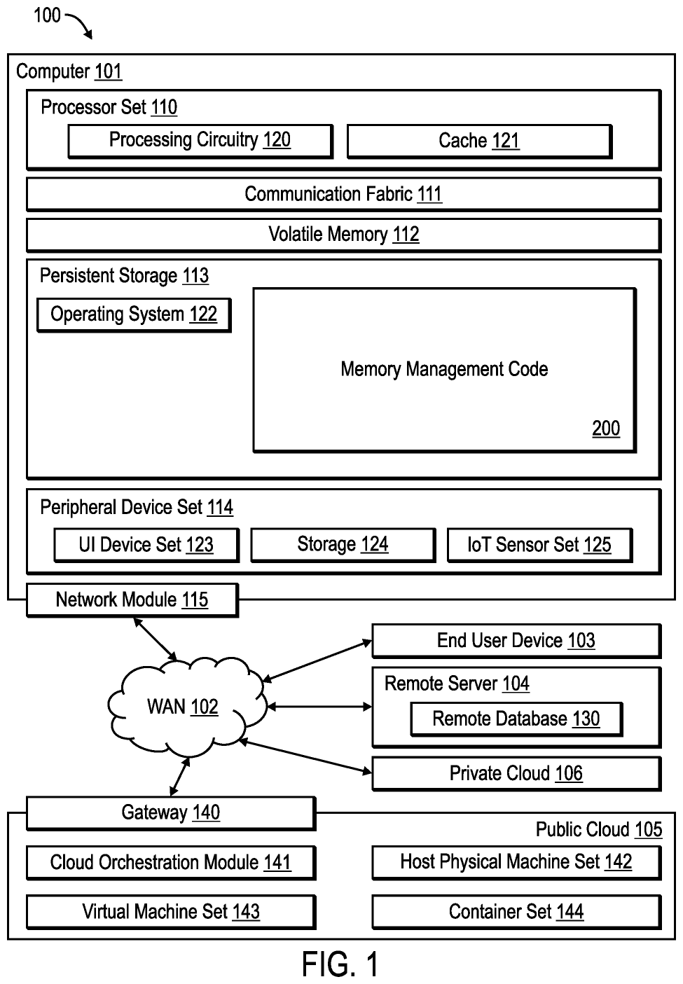

Computing environment 100 of FIG. 1 contains an example of an environment for the execution of at least some of the computer code involved in performing the inventive methods, such as memory management code 200. In addition to block 200, computing environment 100 includes, for example, computer 101 (e.g., an edge device), wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

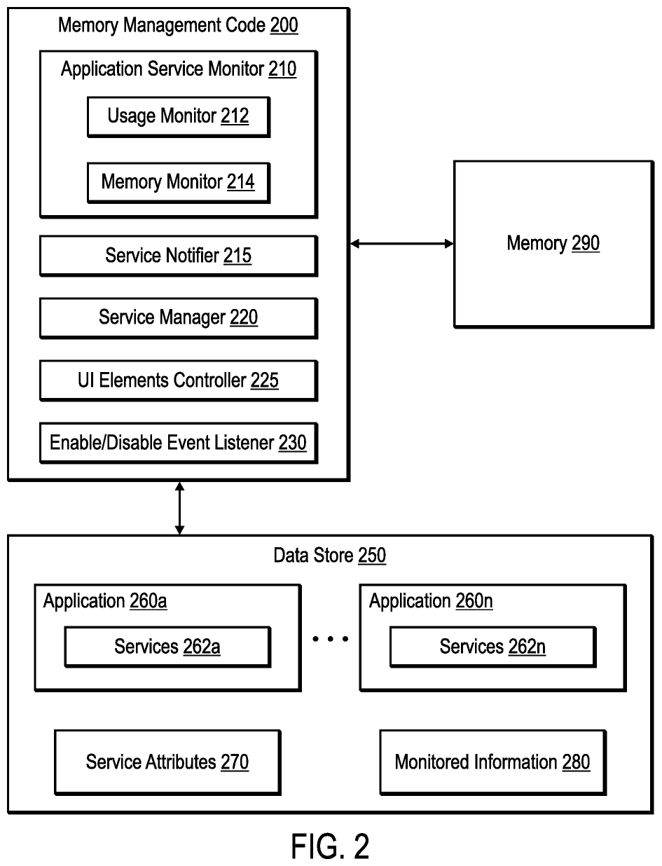

FIG. 2 illustrates, in a block diagram, a computing environment in accordance with certain embodiments. In FIG. 2, the memory management code 200 is connected to memory 290 (e.g., volatile memory 112) and a data store 250. The memory management code 200 includes an application service monitor 210, a service notifier 215, a service manager 220, a UI elements controller 225, and a disable/enable event listener 230. The application service monitor 210 includes a usage monitor 212 (to track how often services are used) and a memory monitor 214 (to monitor whether the memory usage has exceeded a threshold).

The data store 250 stores applications 260a . . . 260n, service attributes 270, and monitored information 280. Each of the applications 260a . . . 260n includes services 262a . . . 262n and may be referred to as a bundled application. In certain embodiments, similar services 262a . . . 262n may be bundled in one application 260a . . . 260n. Each service 262a . . . 262n has application logic that may be executed (i.e., run) on an application framework (e.g., a virtual machine).

In certain embodiments, the memory management code 200 identifies a service 262a . . . 262n of an application 260a . . . 260n that may be disabled based on the frequency of use of that service 262a . . . 262n. Based on free space in memory, the memory management code 200 may also enable a service 262a . . . 262n that is currently disabled. In particular, the memory management code 200 disables and enables the User Interface (UI) for that service 262a . . . 262n dynamically based on how much free space is available in the memory 290. In certain embodiments, disabling the UI element for a service includes making a modification to the UI element so that the UI element is unavailable (e.g., cannot be selected), which makes that service unavailable (e.g., cannot be selected). In certain embodiments, disabling a UI element may be performed by greying out the UI element.

In certain embodiments, free space is space in memory that has not been allocated to another application or service.

In certain embodiments, a current service 262a . . . 262n of the application 260a . . . 260n that is executing may be swapped out for a new service 262a . . . 262n of the application 260a . . . 260n that is to be executed. In such cases, the application logic of both of the services 262a . . . 262n are loaded into the memory 290 while swapping is under way, but, if the memory 290 does not have free space for both of the services 262a . . . 262n, then, the new service 262a . . . 262n is not executed.

Each application 260a . . . 260n has a maximum memory size (max mem) for executing the services 262a . . . 262n. If free space in the memory 290 is not enough to reserve the maximum memory size for starting a new service 262a . . . 262n, that start fails or another service 262a . . . 262n is terminated to free space in the memory 290 for the new service 262a . . . 262n.

In certain embodiments, the memory management code 200 disables and enables the UI element for services of an application based on the usage rate and amount of memory used by that service so that a user may be able to use memory that is allocated for non-frequently used services if the entire available memory is running out of free space (i.e., memory usage exceeds a threshold).

In certain embodiments, the application bundles multiple services, and those services are started via a UI of the application.

In certain embodiments, the memory management code 200 monitors usage rate (i.e., frequency of use) of services in an application, sets a priority for each of the services, and disables or enables that UI element dynamically based on the amount of available memory and based on the priority (e.g., a lower priority service may be disabled before a higher priority service).

In certain embodiments, the memory management code 200 recognizes the services as a hierarchical structure. The memory management code 200 uses the hierarchical structure to disable a lower-level unused service to free memory. The memory management code 200 also uses the hierarchical structure to determine which service the application returns to after ending execution of a current service.

In certain embodiments, the memory management code 200 determines which service the application is executing from an attribute of the start trigger, where the start trigger is a UI element (e.g., a button, a menu, an icon, etc.) of that application by which a user selected the service of the application. In certain embodiments, the memory management code 200 stores the service identifier (ID) for the start triggers. For example, the service IDs may be stored as service attributes 270 of pre-defined UI elements or custom UI elements. The memory management code 200 also provides an Application Programming Interface (API) to enable users (e.g., application programmers) to specify the service attributes 270 of custom UI elements (e.g., in areas of a displayed image, such as buttons, which are also known as image maps). The users do not need to know how the usage rate is monitored. Instead, the users just specify the service ID for the start point of each service. A UI element may also be referred to as a UI part.

In certain embodiments, the memory management code 200 recognizes the end of the service when a different type of service is started or when the end of the service is specified by the API.

In certain embodiments, the memory management code 200 disables or enables the service based on the amount of memory available. The memory management code 200 also disables (a UI element that is currently enabled) or enables (a UI element that is currently disabled) for the corresponding service ID based on whether the service is determined to be disabled or enabled. For pre-defined UI elements, based on the service attribute describing the service ID, when the service is disabled or enabled, the UI element for that service is, respectively, disabled or enabled automatically. For a custom UI element, a notification is sent as the trigger for enabling or disabling that UI element, and the memory management code 200 responds to the trigger by disabling or enabling that UI element.

In certain embodiments, the memory management code 200 may monitor the memory usage of the services in the application in each user's environment. The memory management code 200 assumes that each application defines the maximum memory size of each service provided by that application. For example, an application may have a file that specifies the application's attributes, and these may be used to define pairs of service ID of a service and memory size for the service. The memory size requested may be larger than the memory size actually used because the developer of the application adds some margin to the memory size expected to be used. By monitoring the actual memory size used by each user, the memory management code 200 is more efficient and precise. The memory management code 200 monitors memory usage based on the service ID defined for a UI element.

The usage monitor 212 of the memory management code 200 monitors the usage rate of services in an application and sets priorities (e.g., low, medium, high) to disable and enable the UI elements corresponding to the services. In certain embodiments, the memory management code 200 may start an application with one or more UI elements disabled to make memory usage lower.

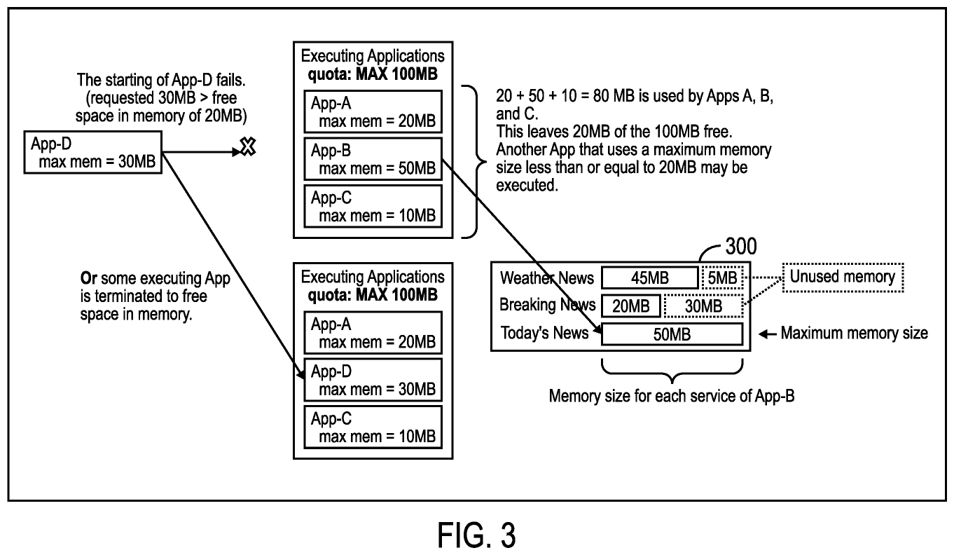

FIG. 3 illustrates an example of memory waste in accordance with certain embodiments. In FIG. 3, executing applications are allocated a maximum memory size of 100 MegaBytes (MB). Executing applications App-A (20 MB), App-B (50 MB), and App-C (10 MB) use 80 MB of the 100 MB of the memory, which leaves 20 MB of free space in the memory. If a request to start App-D, which uses 30 MB of memory, is received, then, either the start fails because App-D uses 30 MB of memory and there is free space of 20 MB in the memory or one of App-A, App-B or App-C is terminated to allow App-D to execute.

Each of the applications App-A, App-B, App-C or App-D may combine several services. Within an application, one service at a time executes.

If one service of an application executes at a time, then, the maximum memory definition for the application may be based on the amount of memory used by the largest service in the application.

In the example of FIG. 3, App-B corresponds to a bundled News application with three services: a “Weather News” service (with voice and images, using 45 MB of the memory), a “Breaking News” service (with voice, using 20 MB of the memory), and a “Today's News” service (with a video stream, using 50 MB of the memory), each of which execute one at a time. Therefore, the defined maximum memory size for the bundled News application may be set to the memory size for “Today's News” (50 MB) because playback of the video stream uses the largest amount of memory among the three services. As shown in box 300, there is unused memory of 5 MB for the “Weather News” service and unused memory of 30 MB for the “Breaking News” service. The “breaking News” service provides a short playback of a news flash using voice. For a user who frequently uses the “Breaking News” service while driving a car (while not using the “Today's News” service often), setting aside the maximum amount of memory of 50 MB for the bundled News application leads to unused memory of 30 MB of memory (i.e., a waste of 30 MB memory that is allocated or reserved for the bundled News application). This is because the amount of memory of 50 MB for playback of the video stream for the “Today's News” service is more than the amount of memory of 20 MB for the “Breaking News” service.

With embodiments, the maximum memory size allocated to the bundled News application is set to 20 MB due to the frequency of use of the “Breaking News” service. Then, App-A (20 MB), App-B (20 MB), App-C (10 MB), and App-D (30 MB) may execute using 80 MB of the allocated 100 MB of the memory.

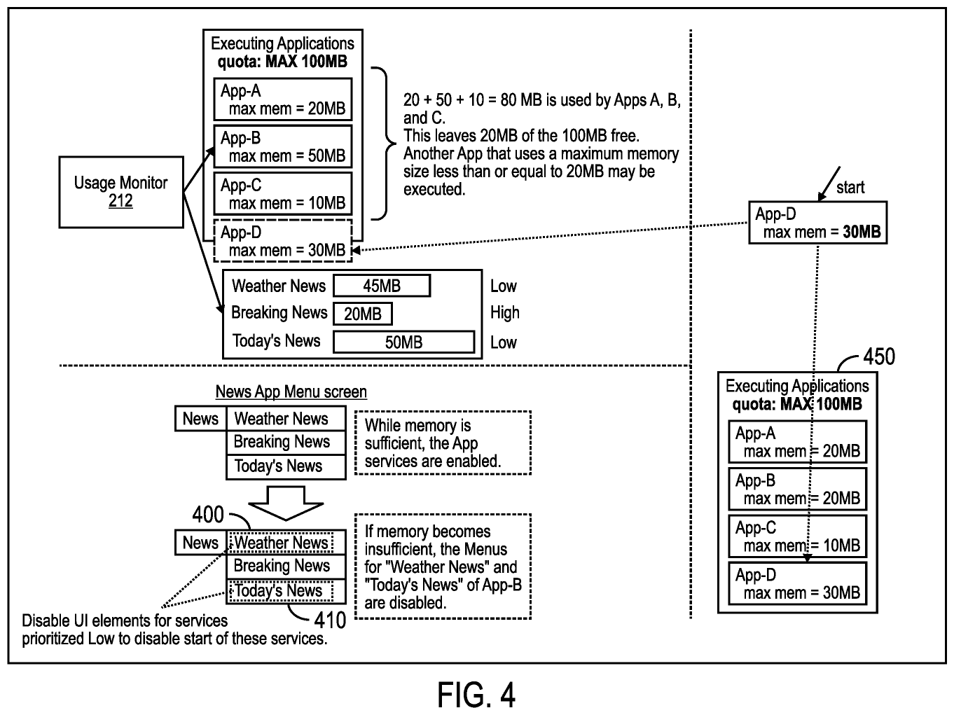

FIG. 4 illustrates an example of disabling services in accordance with certain embodiments. In FIG. 4, executing applications are allocated a maximum memory size of 100 MegaBytes (MB). Executing applications App-A (20 MB), App-B (50 MB), and App-C (10 MB) use 80 MB of the 100 MB of the memory, which leaves 20 MB of free space in the memory. If a request to start App-D, which uses 30 MB of memory, is received, the memory management code 200 frees more space of the 100 MB in memory so that App-D may be executed.

In particular, the usage monitor 212 monitors the frequency of use of the services of App-B and gives them priorities. In this case, the usage monitor 212 determines that “Breaking News” is used more frequently, and the usage monitor 212 ranks “Breaking News” as High and ranks the other services (“Weather News” and “Today's News”) as Low. Then, the memory management code 200 disables the UI elements (menus 400, 410) for these services (“Weather News” and “Today's News”) ranked as Low for App-B. In FIG. 4, the disabled menus 400, 410 are illustrated with dotted boxes merely as an example. In various embodiments, the disabled menus 400, 410 may be shown as greyed out, may be shown with a line through them, etc. When the menus are disabled, the low ranked services may not be selected and started. In addition, by disabling the Menus (and therefore the corresponding Low usage services in App-B), the maximum memory size of App-B may be reduced to 20 MB. Thus, the memory management code 200 adjusts the memory 450 for App-B from 50 MB to 20 MB, where 20 MB is the amount of memory used by the “Breaking News” service. With this adjustment, App-A (20 MB), App-B (20 MB), App-C (10 MB), and App-D (30 MB) may execute using 80 MB of the allocated 100 MB of the memory.

In certain embodiments, an application resource assigner adjusts (e.g., decreases) the memory allocated to an application when one or more services are disabled and notifies the service manager 220 via service notifier 215. The service manager 220 notifies the UI elements controller 225 to disable the UI elements corresponding to the adjusted (disabled) one or more services.

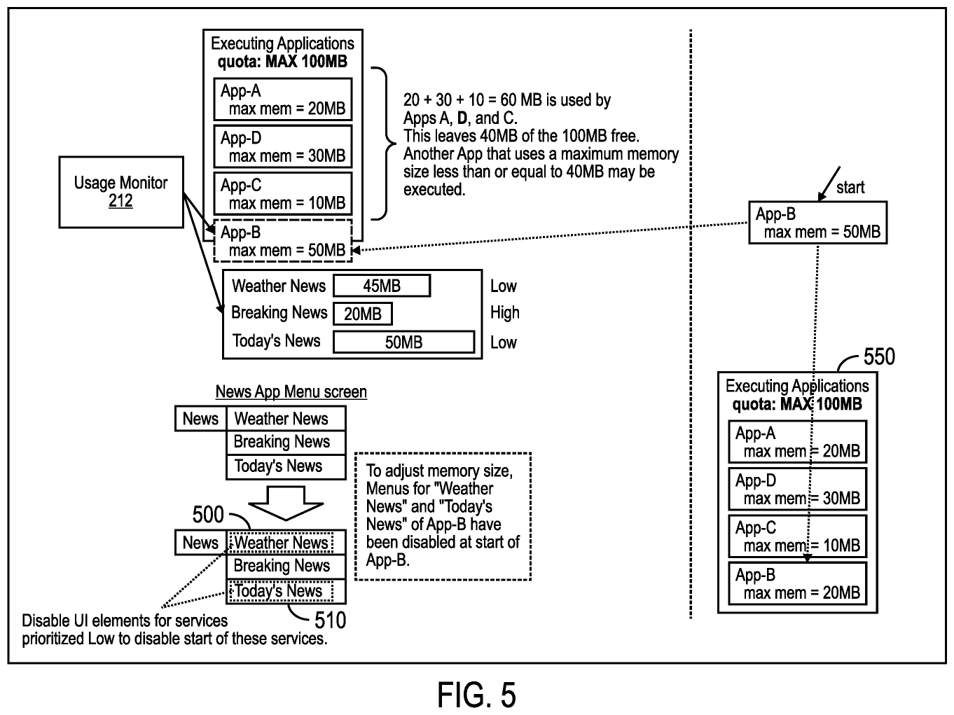

FIG. 5 illustrates an example of starting an application with disabled services in accordance with certain embodiments. In FIG. 5, App-A (20 MB), App-C (10 MB), and App-D (30 MB) are executing. Then, a request to start App-B is received. In this example, the memory management code 200 starts App-B with UI elements (menus 500, 510) disabled for low ranking services (“Weather News” and “Today's News”), and App-B is started with an allocation of 20 MB of the memory. With this adjustment, App-A (20 MB), App-D (30 MB), App-C (10 MB), and App-B (20 MB) may execute using 80 MB of the allocated 100 MB of the memory. In FIG. 5, the disabled menus 500, 510 are illustrated with dotted boxes merely as an example. In various embodiments, the disabled menus 500, 510 may be shown as greyed out, may be shown with a line through them, etc.

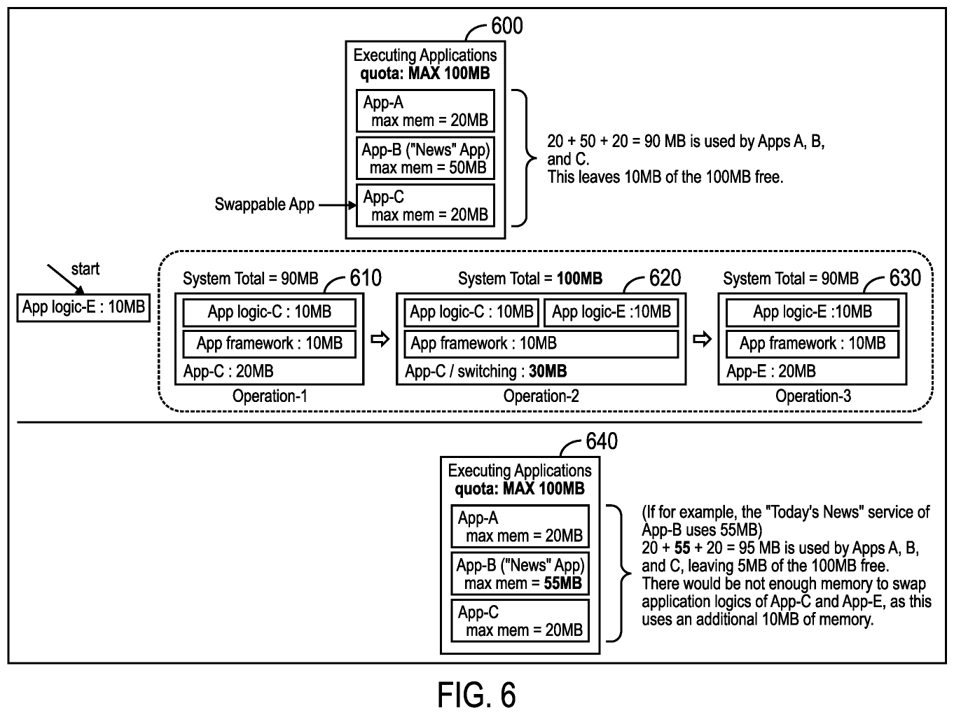

FIG. 6 illustrates an example of swapping applications in accordance with certain embodiments. In FIG. 6, executing applications are allocated a maximum memory size of 100 MB. Executing applications App-A (20 MB), App-B (50 MB), and App-C (20 MB) use 90 MB of the 100 MB of the memory (box 600), which leaves 10 MB of free space in the memory. Although the maximum memory defined for App-C is 20 MB, the application logic for App-C uses 10 MB. In operation-1 (box 610), the application logic for App-C is executing, and the maximum memory allocated to executing applications is 100 MB, with 90 MB being used. Then, a request to start App-E is received, which uses 10 MB of memory, and, in operation-2 (box 620), both the application logic for App-C (10 MB) and the application logic for App-E (10 MB) are in memory during the swap, with 100 MB of the 100 MB maximum memory allocated being used temporarily Then, in operation-3 (box 630), the application logic for App-E executes, with 90 MB of the 100 MB maximum memory allocated being used.

However, in some cases, if memory is not enough for performing the swap of application logics, the new application App-E is not started. For example, if the executing applications App-A (20 MB), App-B (55 MB), and App-C (20 MB) use 95 MB of the 100 MB of the memory (box 640), which leaves 5 MB of free space in the memory, there is not enough free space in memory to start App-E. With embodiments, the maximum memory size allocated to App-B may be set to 20 MB due to the frequency of use of the “Breaking News” service. Then, the executing applications App-A (20 MB), App-B (20 MB), and App-C (20 MB) use 60 MB of the 100 MB of the memory, and there is an additional 40 MB to allow for App-C and App-E to be swapped.

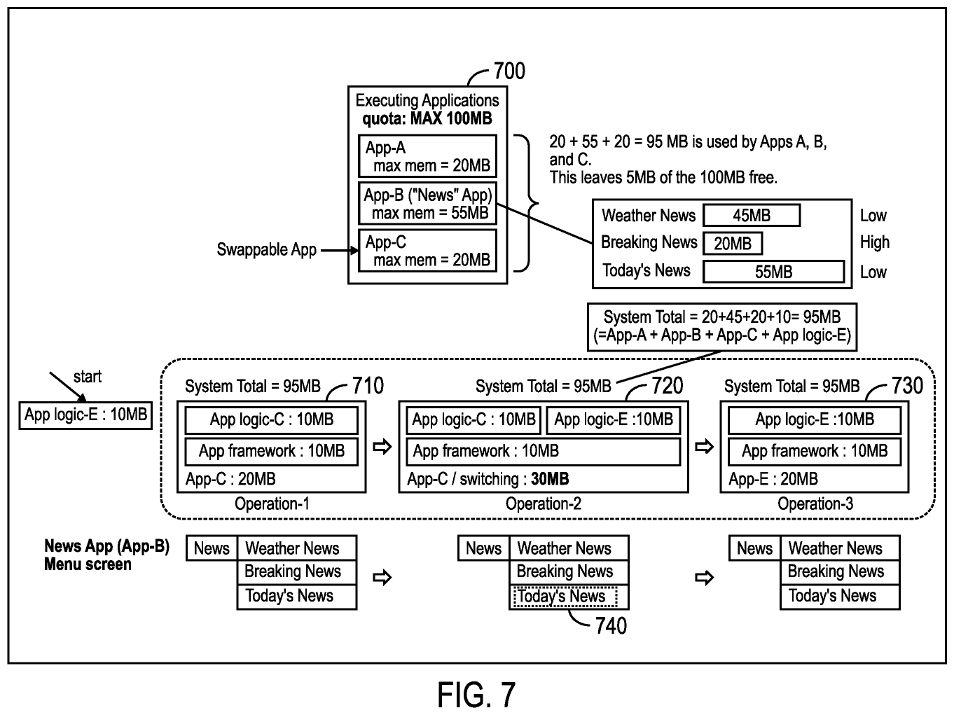

FIG. 7 illustrates an example of allocating temporary memory in accordance with certain embodiments. In FIG. 7, executing applications are allocated a maximum memory size of 100 MB. Executing applications App-A (20 MB), App-B (50 MB), and App-C (20 MB) (where App-C (20 MB) is swappable) use 95 MB of the 100 MB of the memory (box 700).

App-E (10 MB) is started and is to be swapped with App-C. App-B has three services 700. In this example, during operation-1 (box 710), the application logic for App-C is executing. During operation-2 (box 720) the memory management code 200 disables the UI element (menu 740 for “Today's News”) of App-B. Because the maximum memory of App-B becomes 45 MB, there is space in memory to swap the application logic of App-C with the application logic of App-E. During operation-3 (box 730), the memory monitor 214 re-enables the UI element (Menu for “Today's News”) of App-B after the swap completes successfully. Thus, in this example, the UI element of App-B is temporarily disabled to allocate the memory used by that UI element for the swap of App-C and App-E. In FIG. y, the disabled menu 740 is illustrated with a dotted box merely as an example. In various embodiments, the disabled menu 740 may be shown as greyed out, may be shown with a line through them, etc.

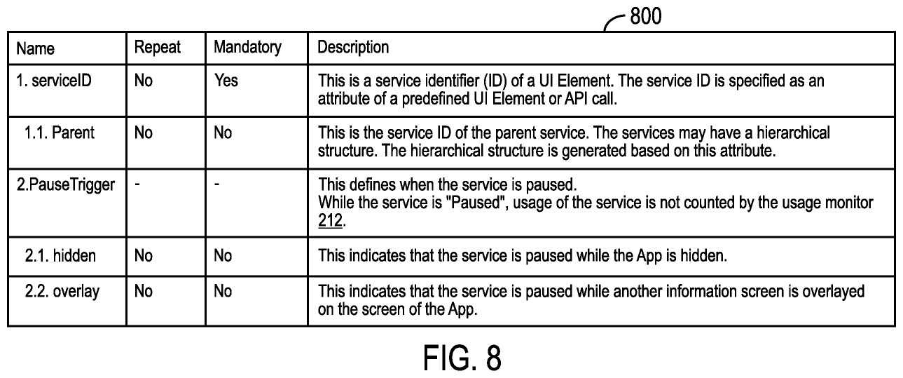

FIG. 8 illustrates service attributes 800 in accordance with certain embodiments. In certain embodiments, a UI element has the following service attributes 800: a service identifier (ID), a parent service ID, a pause trigger, an indication of hidden, and an indication of overlay. The service attributes 800 are an example of the service attributes 270.

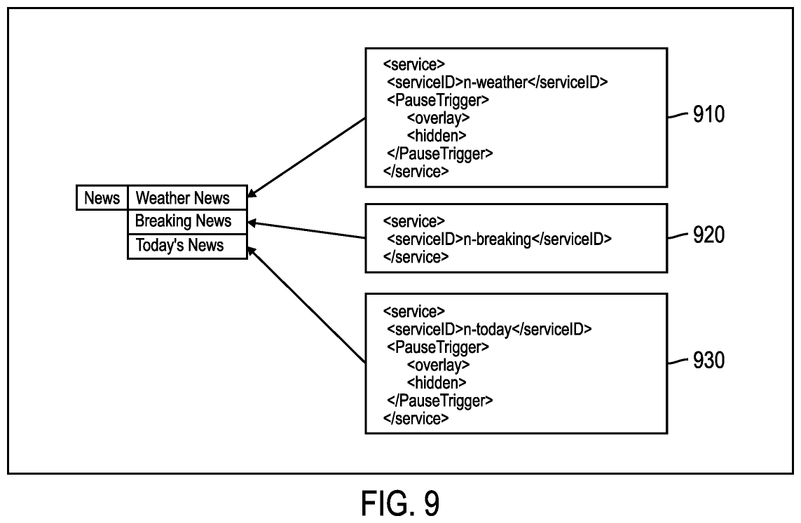

FIG. 9 illustrates example an expression of a service attribute in accordance with certain embodiments. In this example, the attributes are expressed in extensible Markup Language (XML) 910, 920, 930. Suppose the application developer wants the sound playback of “Breaking News” to continue (or count as “using” by the usage monitor 212) when App-B becomes hidden or overlayed, and also wants other services (“Weather News” and “Today's News”) to pause playback (or not count as “using” by the usage monitor 212) when App-B becomes hidden or overlayed. In FIG. 9, since the application developer wants the “Breaking News” service to count as being used, the “Pause Trigger” attribute is not specified for the “Breaking News” service. When “parent” attributes are specified, the memory management code 200 generates the hierarchical structure of the service as an attribute defined.

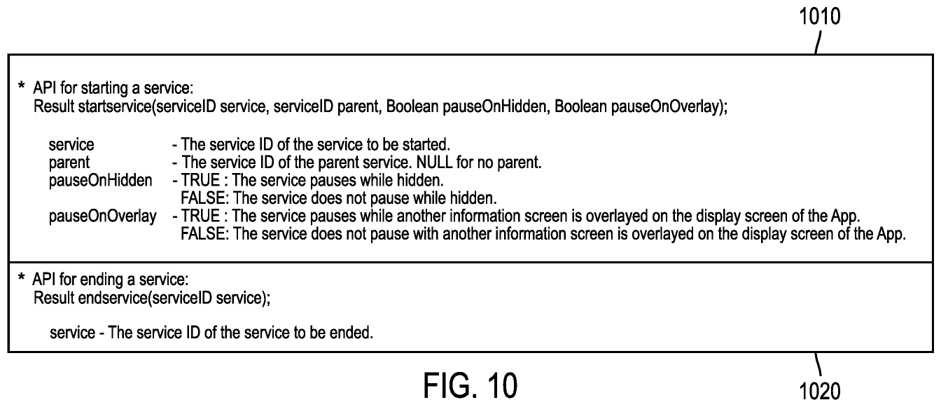

FIG. 10 illustrates examples of APIs in accordance with certain embodiments. The start and end of a service of an application may be specified by an API that specifies the attributes of that application. For example, to start a service the API 1010 (startservice (serviceID service, serviceID parent, Boolean pauseOnHidden, Boolean pauseOnOverlay)) may be invoked, while, to end the service, the API 1020 (endservice (serviceID service)) may be invoked. In certain embodiments, the application service monitor receives and processes the APIs.

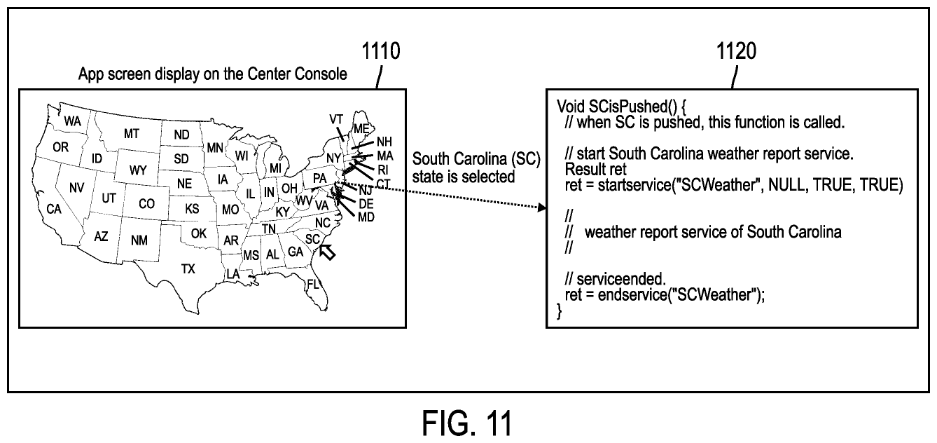

FIG. 11 illustrates an example of using an API in accordance with certain embodiments. In FIG. 11, a map 1110 is displayed on an App screen on the center console. In this example, each State on the map 1110 works like a button (e.g., as in an Image Map). When a State is selected, the App starts the weather report service of that State using the startservice ( ) and endservice ( ) APIs 1120.

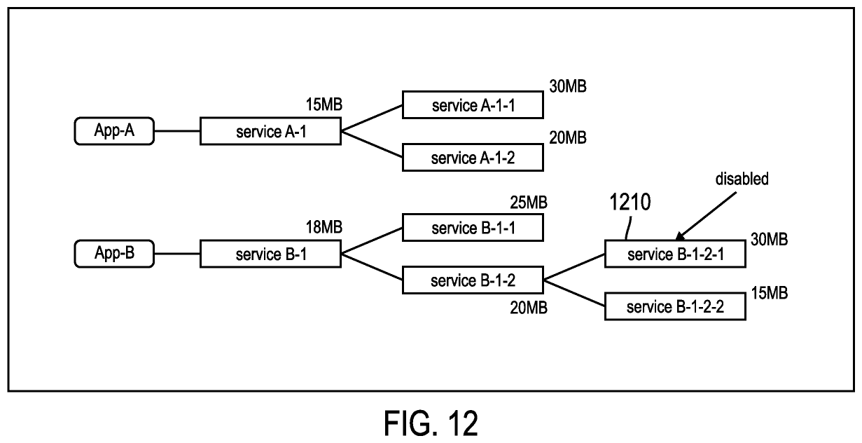

FIG. 12 illustrates selection of a service to disable using a hierarchical structure of the services in accordance with certain embodiments. In certain embodiments, the services are in a hierarchical structure, and the memory management code 200 selects a lower-level unused service to disable to free space in memory. For example, if 30 MB of memory is to be freed, the memory management code 200 selects and disables service B-1-2-1 1210 of App-B. In this example, the priority determined by usage rate is the same for service B-1-2-1 1210 of App-B and service A-1-1 of App-A. Also, in this example, service B-1-2-1 1210 of App-B is at a lower-level than service A-1-1 of App-A. This is based on determining that services at lower (or deeper) levels are unlikely to be frequently used. However, in other embodiments, the memory management code 200 may select a service to disable based on other criteria (e.g., using the hierarchical structure or receiving a selection hint).

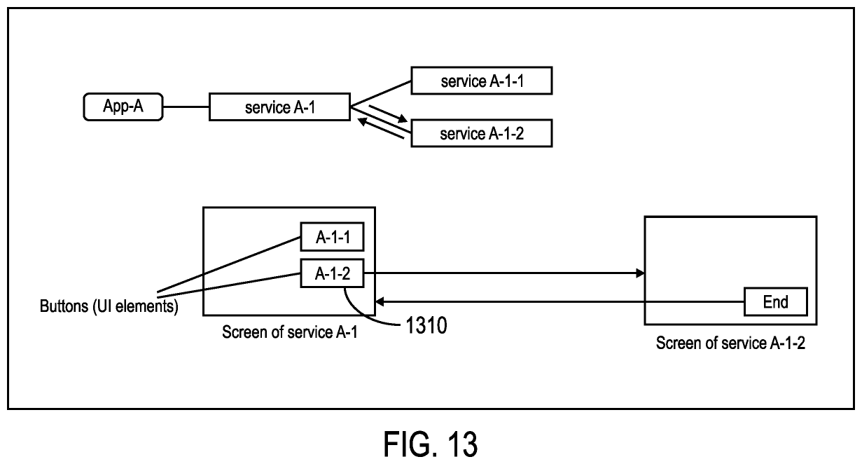

FIG. 13 illustrates use of a hierarchical structure to define a service to return to in accordance with certain embodiments. In FIG. 13, when a button (a UI element) for “service A-1-2” 1310 is selected, the service “service A-1-2” starts. In this example, At the end of “service A-1-2”, the API endservice ( ) is called and processing returns to service A-1 (the parent) without an explicit specification of a service to return to. However, in other examples, there may be an explicit specification of a service to return to once a service ends.

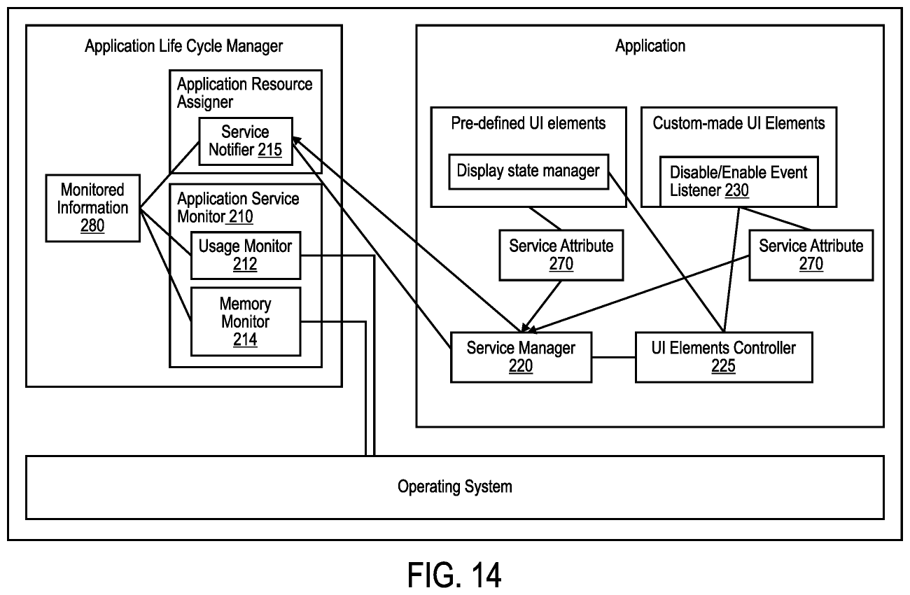

FIG. 14 illustrates, in a block diagram, interaction of components of the memory management code 200 in accordance with certain embodiments. The application service monitor 210 monitors the usage rate of services and memory usage. The application service monitor 210 includes a usage monitor 212 that monitors the usage of the service. For example, the usage monitor 212 may get CPU usage rates from the operating system while each service is executing. The application service monitor 210 includes a memory monitor 214 that monitors the maximum memory usage of the service. For example, the memory monitor 214 may get the peak memory usage during the service execution, and the memory monitor 214 stores this in the monitor information 280 per application.

The application resource assigner monitors the entire memory usage, and, if the memory usage exceeds a threshold, the service notifier 215 determines which service of the application is to be disabled based on the monitor information 280 (i.e., based on memory usage size and priority). Then, the service notifier 215 sends the notifications to the service manager 220 of applications that have UI elements to be disabled. For the case in which the UI is disabled at the start of an application, the notification is done during the startup procedure of that application so that UI element is disabled when the screen for the application is displayed.

When the service manager 220 gets that notification, the service manager 220 calls the UI elements controller 225, and the UI elements controller 225 disables the pre-defined UI elements or sends a notification to the disable/enable event listener 230 of a custom-made UI element.

The operations for re-enabling UI elements may be, in some ways, similar to disabling the UI elements. When the status of memory shortage is cleared (e.g., the memory usage is less than or equal to the threshold), the service notifier 215 determines which service is enabled and sends the notification to the service manager 220 of applications that have UI elements to be enabled. When the service manager 220 gets that notification, the service manager 220 calls the UI elements controller 225, and the UI elements controller 225 enables the disabled UI elements or sends a notification to the disable/enable event listener 230 of a custom-made UI element.

The service manager 220 recognizes the service attributes of an application (e.g., service attributes 800) and sends the service attributes to the service notifier 215. The services attributes that the service notifier 215 receives are shared and used by the application service monitor 210 and the service notifier 215.

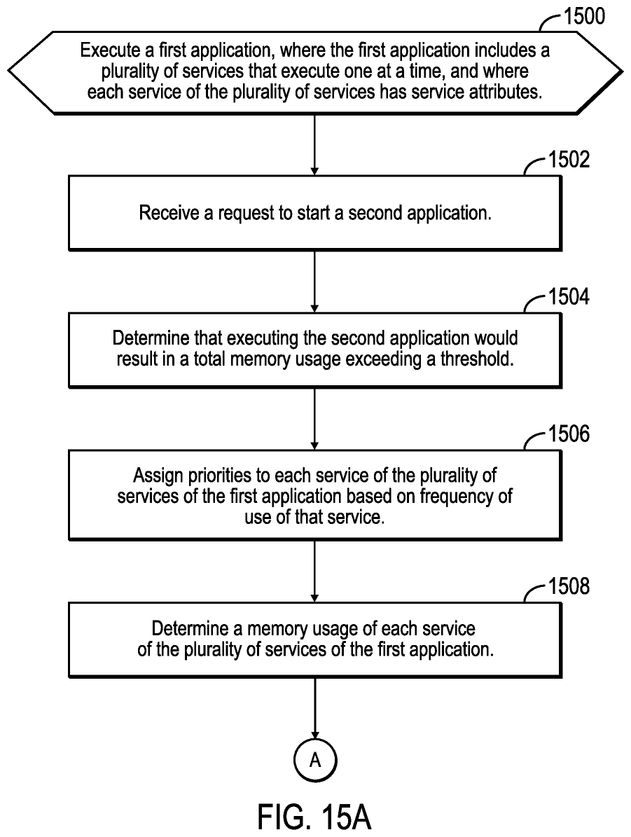

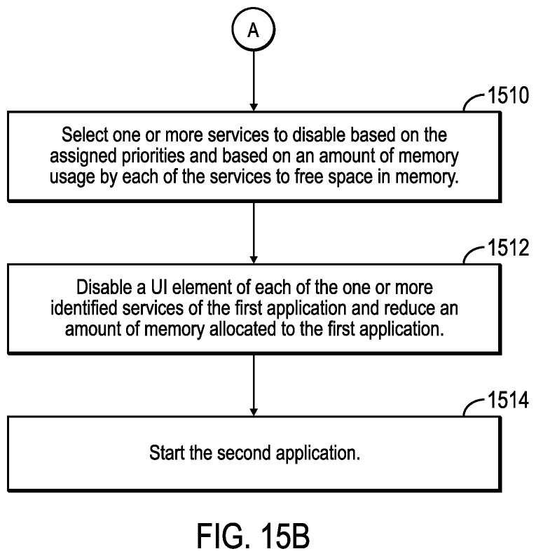

FIGS. 15A and 15B illustrate, in a flowchart, operations for disabling one or more services to start a new application in accordance with certain embodiments. Control begins at block 1500 with the memory management code 200 executing a first application, where the first application includes a plurality of services that execute one at a time, and where each service of the plurality of services has service attributes.

In block 1502, the memory management code 200 receives a request to start a second application. In block 1504, the memory management code 200 determines that executing the second application would result in a total memory usage exceeding a threshold (i.e., there is not enough free space in memory to execute the second application).

In block 1506, the memory management code 200 assigns priorities to each service of the plurality of services of the first application based on frequency of use of that service. In block 1508, the memory management code 200 determines a memory usage of each service of the plurality of services of the first application. From block 1508 (FIG. 15A), processing continues to block 1510 (FIG. 15B).

In block 1510, the memory management code 200 selects one or more services to disable based on the assigned priorities and based on an amount of memory usage by each of the services to free space in memory. In particular, the selection may be based on the assigned priorities, how much memory each service uses, and how much memory is to be used to start the second application.

In block 1512, the memory management code 200 disables a UI element of each of the one or more identified services of the first application and reduces an amount of memory allocated to the first application. In block 1514, the memory management code 200 starts the second application.

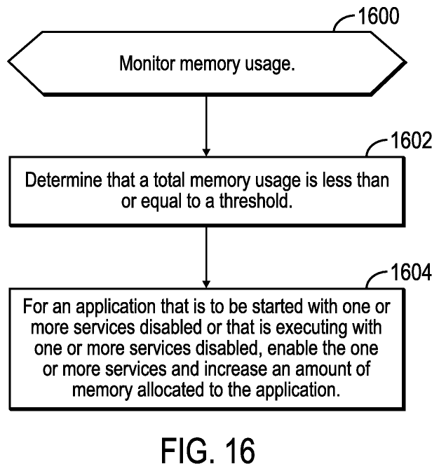

FIG. 16 illustrates, in a flowchart, operations for enabling one or more services in accordance with certain embodiments. Control begins at block 1600 with the memory management code 200 monitoring memory usage. In block 1602, the memory management code 200 determines that a total memory usage is less than or equal to a threshold. In block 1604, for an application that is to be started with one or more services disabled or that is executing with one or more services disabled, the memory management code 200 enables the one or more services and increases an amount of memory allocated to the application.

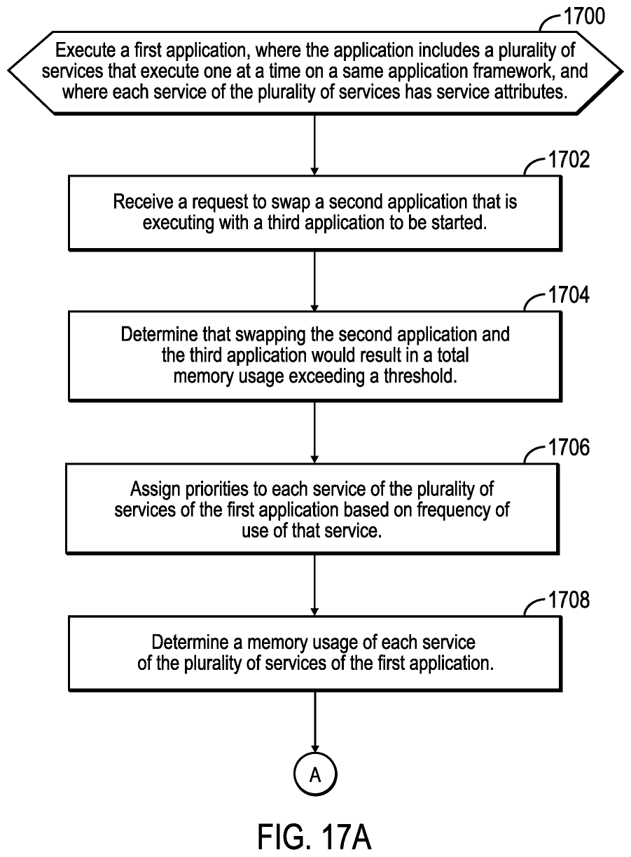

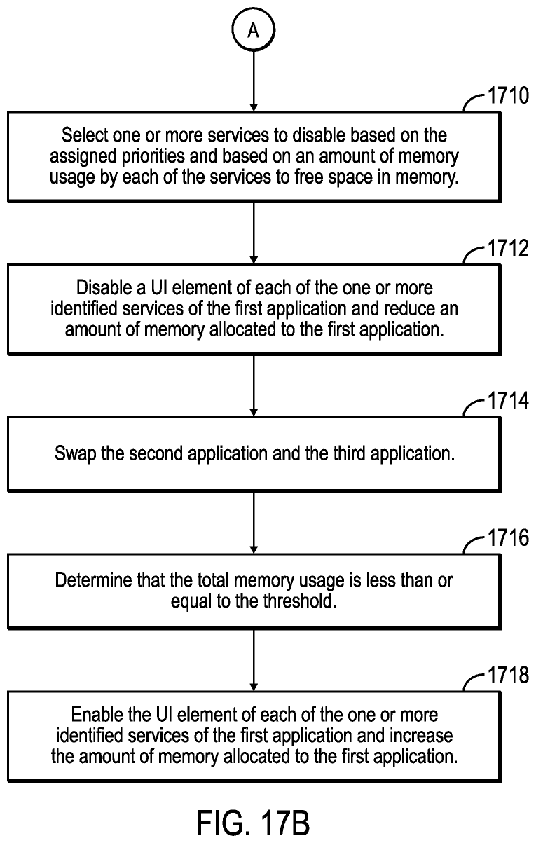

FIGS. 17A and 17B illustrate, in a flowchart, operations for temporarily disabling one or more services to swap applications in accordance with certain embodiments. Control begins at block 1700 with the memory management code 200 executing a first application, where the application includes a plurality of services that execute one at a time on a same application framework, and where each service of the plurality of services has service attributes.

In block 1702, the memory management code 200 receives a request to swap a second application that is executing with a third application to be started. In block 1704, the memory management code 200 determines that swapping the second application and the third application would result in a total memory usage exceeding a threshold (i.e., there is not enough free space in memory to perform the swap).

In block 1706, the memory management code 200 assign priorities to each service of the plurality of services of the first application based on frequency of use of that service. In block 1708, the memory management code 200 determines a memory usage of each service of the plurality of services of the first application. From block 1708 (FIG. 17A), processing continues to block 1710 (FIG. 17B).

In block 1710, the memory management code 200 selects one or more services to disable based on the assigned priorities and based on an amount of memory usage by each of the services to free space in memory. In particular, the selection may be based on the assigned priorities, how much memory each service uses, and how much memory is to be used to swap the second application and the third application.

In block 1712, the memory management code 200 disables a UI element of each of the one or more identified services of the first application and reduces an amount of memory allocated to the first application.

In block 1714, the memory management code 200 swaps the second application and the third application. In block 1716, the memory management code 200 determines that the total memory usage is less than or equal to the threshold. In block 1718, the memory management code 200 enables the UI element of each of the one or more identified services of the first application and increases the amount of memory allocated to the first application.

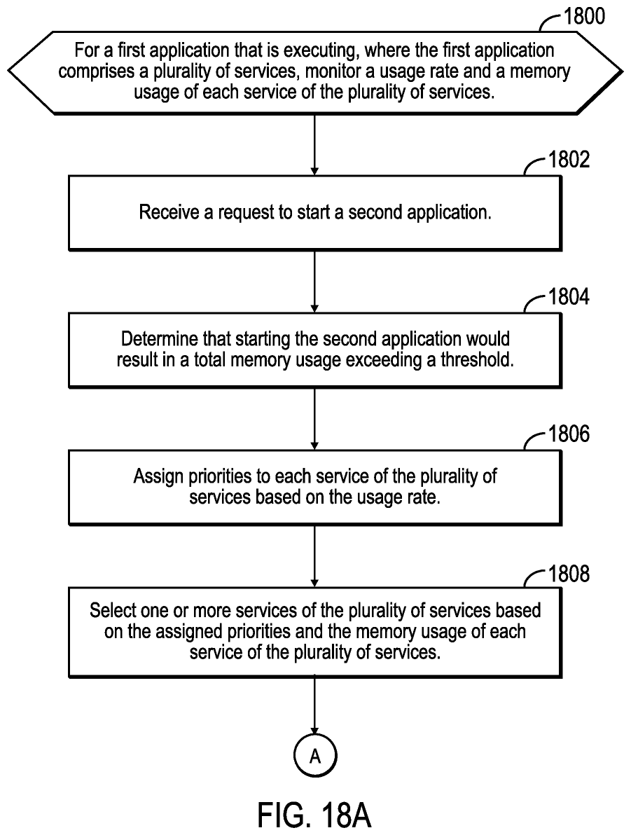

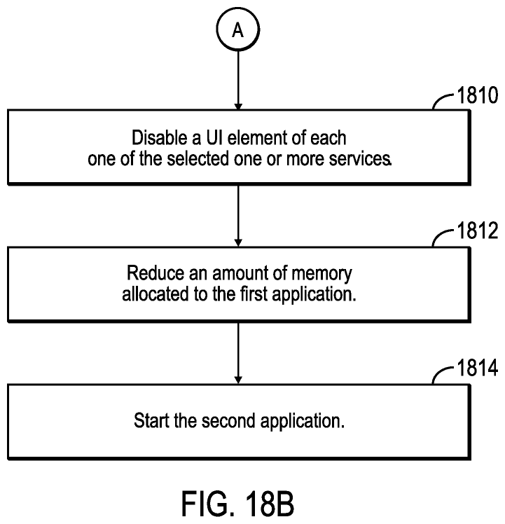

FIGS. 18A and 18B illustrate, in a flowchart, freeing space in memory by disabling one or more services of an application in accordance with certain embodiments. Control begins at block 1800 with the memory management code 200, for a first application that is executing, where the first application comprises a plurality of services, monitoring a usage rate and a memory usage of each service of the plurality of services.

In block 1802, the memory management code 200 receives a request to start a second application. In block 1804, the memory management code 200 determines that starting the second application would result in a total memory usage exceeding a threshold.

In block 1806, the memory management code 200 assigns priorities to each service of the plurality of services based on the usage rate. In block 1808, the memory management code 200 selects one or more services of the plurality of services based on the assigned priorities and the memory usage of each service of the plurality of services. From block 1808 (FIG. 18A), processing continues to block 1810 (FIG. 18B). In particular, the selection may be based on the assigned priorities, how much memory each service uses, and how much memory is to be used to start the second application.

In block 1810, the memory management code 200 disables a UI element of each one of the selected one or more services. In block 1812, the memory management code 200 reduces an amount of memory allocated to the first application. In block 1814, the memory management code 200 starts the second application.

In certain embodiments, in response to determining that the total memory usage is less than or equal to the threshold, the memory management code 200 enables the UI element of each one of the selected one or more services and increases the amount of memory allocated to the first application.

In certain embodiments, each of the services has associated service attributes, and wherein the associated service attributes determine when usage of the service is counted in the usage rate.

In certain embodiments, a hierarchical structure is created from the plurality of services. In such embodiments, a parent service (a “higher-level service”) is at a higher-level of the hierarchical structure and a child service (a “lower-level service”) is at a lower-level of the hierarchical structure. With embodiments, the lower-level services are selected to be disabled before the higher-level services are selected to be disabled. In certain embodiments, a combination of services at different levels of the hierarchical structure may be selected to be disabled based on an amount of memory to be freed.

In certain embodiment, when execution of a lower-level service of the hierarchical structure ends, processing control returns to a higher-level service (e.g., a parent service).

In certain embodiments, the UI element of each service is either a pre-defined UI element or a custom UI element.

In certain embodiments, applications may have UI elements as containers on an edge device. In such embodiments, the memory management code 200 may be used to improve memory usage.

In certain embodiments, the memory management code 200 is applicable to edge devices, such as a car navigation system, a connected home appliance, a connected manufacturing machine, etc.

In certain embodiments, the memory management code 200 manages services running in an application on a same application framework (base VM). The memory management code 200 monitors usage rates and memory usage (e.g., CPU usage rate, number of times the service or the services UI element has been activated, a number of API calls to start or end the service, and a maximum memory usage) for each of the services. Based on the monitored usage rate and memory usage of each of the services, the memory management code 200 assigns priorities to each of the services. The priorities may be used to select a service to be disabled. In response to the memory usage exceeding a threshold, the memory management code 200 selects a service to disable based on the assigned priorities. The memory management code 200 disables the UI element of the service.

In certain embodiments, in response to determining that the memory usage is less than or equal to the threshold, the memory management code 200 enables the service. In certain other embodiments, in response to determining that the memory usage is less than or equal to the threshold, the memory management code 200 enables another service that has been disabled based on the prioritization.

In certain embodiments, each service has service attributes. The service attributes include a service ID identifying a service. The service attributes also specify a hierarchical structure of the service and indicate the way to monitor the service.

In certain embodiments, the monitoring and assigning priorities are further based on the service attributes.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”. “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method, comprising operations for:
for a first application that is executing, wherein the first application comprises a plurality of services, monitoring a usage rate and a memory usage of each service of the plurality of services;
receiving a request to start a second application; and
in response to determining that starting the second application would result in a total memory usage exceeding a threshold,
assigning priorities to each service of the plurality of services based on the usage rate;
selecting one or more services of the plurality of services based on the priorities and the memory usage of each service;
disabling a User Interface (UI) element of each one of the selected one or more services;
reducing an amount of memory allocated to the first application; and
starting the second application.

2. The computer-implemented method of claim 1, further comprising operations for:
in response to determining that the total memory usage is less than or equal to the threshold,
enabling the UI element of each one of the selected one or more services; and
increasing the amount of memory allocated to the first application.

3. The computer-implemented method of claim 1, wherein each service of the plurality of services has associated service attributes, and wherein the associated service attributes determine when usage of the service is counted in the usage rate.

4. The computer-implemented method of claim 1, further comprising operations for:
creating a hierarchical structure from the plurality of services, wherein the hierarchical structure comprises a higher-level service and a lower-level service.

5. The computer-implemented method of claim 4, wherein selecting one or more of the services comprises selecting the lower-level service to disable.

6. The computer-implemented method of claim 4, wherein, in response to execution of the lower-level service ending, returning processing control to the higher-level service.

7. The computer-implemented method of claim 1, wherein the UI element of each one of the selected one or more services comprises a pre-defined UI element or a custom UI element.

8. A computer program product, the computer program product comprising a computer readable storage medium having program instructions embodied therewith, the program instructions executable by a processor to cause the processor to perform operations for:
for a first application that is executing, wherein the first application comprises a plurality of services, monitoring a usage rate and a memory usage of each service of the plurality of services;
receiving a request to start a second application; and
in response to determining that starting the second application would result in a total memory usage exceeding a threshold,
assigning priorities to each service of the plurality of services based on the usage rate;
selecting one or more services of the plurality of services based on the priorities and the memory usage of each service;
disabling a User Interface (UI) element of each one of the selected one or more services;
reducing an amount of memory allocated to the first application; and
starting the second application.

9. The computer program product of claim 8, wherein the program instructions are executable by the processor to cause the processor to perform further operations for:
in response to determining that the total memory usage is less than or equal to the threshold,
enabling the UI element of each one of the selected one or more services; and
increasing the amount of memory allocated to the first application.

10. The computer program product of claim 8, wherein each service of the plurality of services has associated service attributes, and wherein the associated service attributes determine when usage of the service is counted in the usage rate.

11. The computer program product of claim 8, wherein the program instructions are executable by the processor to cause the processor to perform further operations for:
creating a hierarchical structure from the plurality of services, wherein the hierarchical structure comprises a higher-level service and a lower-level service.

12. The computer program product of claim 11, wherein selecting one or more of the services comprises selecting the lower-level service to disable.

13. The computer program product of claim 11, wherein, in response to execution of the lower-level service ending, returning processing control to the higher-level service.

14. The computer program product of claim 8, wherein the UI element of each one of the selected one or more services comprises a pre-defined UI element or a custom UI element.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
for a first application that is executing, wherein the first application comprises a plurality of services, monitoring a usage rate and a memory usage of each service of the plurality of services;
receiving a request to start a second application; and
in response to determining that starting the second application would result in a total memory usage exceeding a threshold,
assigning priorities to each service of the plurality of services based on the usage rate;
selecting one or more services of the plurality of services based on the priorities and the memory usage of each service;
disabling a User Interface (UI) element of each one of the selected one or more services;
reducing an amount of memory allocated to the first application; and
starting the second application.

16. The computer system of claim 15, wherein the program instructions further perform operations comprising:
in response to determining that the total memory usage is less than or equal to the threshold,
enabling the UI element of each one of the selected one or more services; and
increasing the amount of memory allocated to the first application.

17. The computer system of claim 15, wherein each service of the plurality of services has associated service attributes, and wherein the associated service attributes determine when usage of the service is counted in the usage rate.

18. The computer system of claim 15, wherein the program instructions further perform operations comprising:
creating a hierarchical structure from the plurality of services, wherein the hierarchical structure comprises a higher-level service and a lower-level service.

19. The computer system of claim 18, wherein selecting one or more of the services comprises selecting the lower-level service to disable.

20. The computer system of claim 18, wherein, in response to execution of the lower-level service ending, returning processing control to the higher-level service.
